(19) United States
(12) Patent Application Publication
(10) Pub. No.: US 2007/0082115 A1
(43) Pub. Date: Apr. 12, 2007

(54) Methods for inducing satiety, reducing food intake and reducing weight

(76) Inventors: William Ronald Aimutis JR., Blaine, MN (US); Steven J. Catani, Athens, GA (US); Steven D. Clarke, North Brunswick, NJ (US); Eugene Terry Finocchiaro, West Amwell, NJ (US); Thomas E. Sox, Ambler, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/245,869

(22) Filed: Oct. 7, 2005

(51) Int. Cl. A23L 1/212

(52) U.S. Cl. 426/617

(57) ABSTRACT

Methods for inducing satiety, reducing food intake, and reducing weight in an animal by ingesting at least one soluble anionic fiber in the presence of a milk source.

### CROSS-REFERENCE TO RELATED APPLICATIONS

This case is related to U.S. patent application Ser. No. ______, entitled “COMPOSITIONS AND METHODS FOR REDUCING FOOD INTAKE AND CONTROLLING WEIGHT” (docket number MSP5038); U.S. patent application Ser. No. ______, entitled “METHODS FOR REDUCING CALORIE INTAKE” (docket number MSP5039), U.S. patent application Ser. No. ______, entitled “COMPOSITIONS AND METHODS FOR INDUCING SATIETY AND REDUCING CALORIC INTAKE” (docket number MSP5040); U.S. patent application Ser. No. ______, entitled “METHODS FOR ACHIEVING AND MAINTAINING WEIGHT LOSS” (docket number MSP5041); U.S. patent application Ser. No. ______, entitled “METHODS FOR REDUCING WEIGHT” (docket number MSP5042); U.S. patent application entitled “COMPOSITIONS AND METHODS FOR REDUCING FOOD INTAKE AND CONTROLLING WEIGHT” (docket number MSP5043); U.S. patent application Ser. No. ______, entitled “COMPOSITIONS AND METHODS FOR REDUCING FOOD INTAKE AND CONTROLLING WEIGHT” (docket number MSP5044); U.S. patent application Ser. No. ______, entitled “METHODS FOR WEIGHT MANAGEMENT” (docket number MSP5045); U.S. patent application Ser. No. ______, entitled “COMPOSITIONS AND METHODS FOR REDUCING FOOD INTAKE AND CONTROLLING WEIGHT (docket number MSP5047); U.S. patent application Ser. No. ______, entitled “FIBER SATIETY COMPOSITIONS” (docket number 10790-056001); and U.S. patent application Ser. No. ______, entitled “FIBER SATIETY COMPOSITIONS” (docket number 10790-056002), each filed concurrently herewith on Oct. 7, 2005.

### FIELD OF THE INVENTION

The present invention is directed to methods of using the ingestible compositions containing at least one soluble anionic fiber in the presence of a milk source to increase satiety, decrease calorie consumption, and reduce weight.

### BACKGROUND OF THE INVENTION

Diabetes and obesity are common ailments in the United States and other Western cultures. A study by researchers at RTI International and the Centers for Disease Control estimated that U.S. obesity-attributable medical expenditures reached $75 billion in 2003. Obesity has been shown to promote many chronic diseases, including type 2 diabetes, cardiovascular disease, several types of cancer, and gallbladder disease.

Adequate dietary intake of soluble fiber has been associated with a number of health benefits, including decreased blood cholesterol levels, improved glycemic control, and the induction of satiety and satiation in individuals. Consumers have been resistant to increasing soluble fiber amounts in their diet, however, often due to the negative organoleptic characteristics, such as, sliminess, excessive viscosity, excessive dryness and poor flavor, that are associated with food products that include soluble fiber.

What is needed is a stable, organoleptically acceptable product that delivers at least one soluble anionic fiber in the presence of a milk source.

### SUMMARY OF THE INVENTION

The present invention solves the above needs by providing a method for inducing satiety in an animal, the method comprising, consisting of, and/or consisting essentially of the step of ingesting at least one soluble anionic fiber and a milk source.

Another embodiment of the present invention is a method for reducing caloric intake in a human or an animal, the method comprising, consisting of, and/or consisting essentially of the step of administering to the animal an effective amount of at least one soluble anionic fibers and a milk source.

A further embodiment of the present invention is method for reducing weight in a human or an animal, the method comprising, consisting of, and/or consisting essentially of the step of administering to the animal at least one soluble anionic fiber and a milk source.

### DETAILED DESCRIPTION OF THE INVENTION

As used herein, unless indicated otherwise, the terms “alginate,” “pectin,” “carrageenan,” “polygeenan,” or “gellan” refers to all forms (e.g., protonated or salt forms, such as sodium, potassium, and ammonium salt forms and having varying average molecular weight ranges) of the soluble anionic fiber type.

As used herein, unless indicated otherwise, the term “alginate” includes not only the material in protonated form but also the related salts of alginate, including but not limited to sodium, potassium, and ammonium alginate.

As used herein, unless indicated otherwise, the term “protected” means that the source has been treated in such a way, as illustrated below, to delay (e.g., until during or after ingestion or until a certain pH range has been reached) reaction of the at least one divalent cation with the soluble anionic fiber as compared to an unprotected divalent cation.

As used herein, the term SE or Satiety Efficiency Index means, unless otherwise defined, caloric reduction in a given meal due to preload divided by the caloric value of the preload. For example, if a person consumes a 1000 calorie lunch without ingesting a preload, but consumes a 900 calorie lunch after ingesting a 200 calorie preload, the preload would have a 0.50 or 50% SE. Another example is a person consumes a 1000 calorie lunch without ingesting a preload, but consumes a 800 calorie lunch after ingesting a 100 calorie preload, the preload would have a 2.0 or 200% SE. As can be seen, the greater the SE, the greater the effect of the preload on the next meal.

Unless otherwise defined, all technical and scientific terms used herein have the same meaning as commonly understood by one of ordinary skill in the art to which this invention pertains. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

As used herein, a recitation of a range of values is merely intended to serve as a shorthand method of referring individually to each separate value falling within the range, and each separate value is incorporated into the specification as if it were individually recited herein.

The compositions of this invention are intended to reduce food intake at consumption levels of dietary fiber much lower than the levels that have previously been reported to reduce food intake. The inventors believe that this arises from the enhanced viscosity produced by the interactions of calcium in milk source at least one soluble anionic fiber.

Soluble Anionic Fiber

Any soluble anionic fiber should be acceptable for the purposes of this invention. Suitable soluble anionic fibers include alginate, pectin, gellan, soluble fibers that contain carboxylate substituents, carrageenan, polygeenan, and marine algae-derived polymers that contain sulfate substituents.

Also included within the scope of soluble anionic fibers are other plant derived and synthetic or semisynthetic polymers that contain sufficient carboxylate, sulfate, or other anionic moieties to undergo gelling in the presence of sufficient levels of cation.

At least one source of soluble anionic fiber may be used in these compositions, and the at least one source of soluble anionic fiber may be combined with at least one source of soluble fiber that is uncharged at neutral pH. Thus, in certain cases, two or more soluble anionic fibers types are included, such as, alginate and pectin, alginate and gellan, or pectin and gellan. In other cases, only one type of soluble anionic fiber is used, such as only alginate, only pectin, only carrageenan, or only gellan.

Soluble anionic fibers are commercially available, e.g., from ISP (Wayne, N.J.), TIC Gums, and CP Kelco.

An alginate can be a high guluronic acid alginate. For example, in certain cases, an alginate can exhibit a higher than 1:1 ratio of guluronic to mannuronic acids, such as in the range from about 1.2:1 to about 1.8:1, e.g., about 1.3:1, about 1.4:1, about 1.5:1, about 1.6:1, or about 1.7:1 or any value therebetween. Examples of high guluronic alginates (e.g., having a higher than 1:1 g:m ratios) include Manugel LBA, Manugel GHB, and Manugel DBP, which each have a g:m ratio of about 1.5.

While not being bound by theory, it is believed that high guluronic alginates can cross-link through divalent cations, e.g., calcium ions, to form gels at the low pH regimes in the stomach. High guluronic alginates are also believed to electrostatically associate with pectins and/or gellans at low pHs, leading to gellation. In such cases, it may be useful to delay the introduction of divalent cations until after formation of the mixed alginate/pectin or alginate/gellan gel, as divalent cationic cross-links may stabilize the mixed gel after formation.

In other cases, an alginate can exhibit a ratio of guluronic to mannuronic acids (g:m ratio) of less than about 1:1, e.g., about 0.8:1 to about 0.4:1, such as about 0.5:1, about 0.6:1, or about 0.7:1 or any value therebetween. Keltone LV and Keltone HV are examples of high-mannuronic acids (e.g., having a g:m ratio of less than 1:1) having g:m ratios ranging from about 0.6:1 to about 0.7:1.

Methods for measuring the ratio of guluronic acids to mannuronic acids are known by those having ordinary skill in the art.

An alginate can exhibit any number average molecular weight range, such as a high molecular weight range (about 2.05×10⁵ to about 3×10⁵ Daltons or any value therebetween; examples include Manugel DPB, Keltone HV, and TIC 900 Alginate); a medium molecular weight range (about 1.38×10⁵ to about 2×10⁵ Daltons or any value therebetween; examples include Manugel GHB); or a low molecular weight range (about 2×10⁴ to about 1.35×10⁵ Daltons or any value therebetween; examples include Manugel LBA and Manugel LBB). Number average molecular weights can be determined by those having ordinary skill in the art, e.g., using size exclusion chromatography (SEC) combined with refractive index (RI) and multi-angle laser light scattering (MALLS).

In certain embodiments of an extruded food product, a low molecular weight alginate can be used (e.g., Manugel LBA), while in other cases a mixture of low molecular weight (e.g., Manugel LBA) and high molecular weight (e.g., Manugel DPB, Keltone HV) alginates can be used. In other cases, a mixture of low molecular weight (e.g., Manugel LBA) and medium molecular weight (e.g., Manugel GHB) alginates can be used. In yet other cases, one or more high molecular weight alginates can be used (e.g., Keltone HV, Manugel DPB).

A pectin can be a high-methoxy pectin (e.g., having greater than 50% esterified carboxylates), such as ISP HM70LV and CP Kelco USPL200. A pectin can exhibit any number average molecular weight range, including a low molecular weight range (about 1×10⁵ to about 1.20×10⁵ Daltons, e.g., CP Kelco USPL200), medium molecular weight range (about 1.25×10⁵ to about 1.45×10⁵ e.g., ISP HM70LV), or high molecular weight range (about 1.50×10⁵ to about 1.80×10⁵, e.g., TIC HM Pectin). In certain cases, a high-methoxy pectin can be obtained from pulp, e.g., as a by-product of orange juice processing.

A gellan soluble anionic fiber can also be used. Gellan fibers form strong gels at lower concentrations than alginates and/or pectins, and can cross-link with divalent cation cations. For example, gellan can form gels with sodium, potassium, magnesium, and calcium. Gellans for use in the invention include Kelcogel, available commercially from CP Kelco.

Fiber levels of from about 1.0 to about 2.8 grams per serving, or about 2.0 to about 5.6 grams per day, when used twice each day, in the compositions of this invention are particularly useful. A preferred range of fiber in the compositions of this invention is about 0.25 g to about 5 g per serving, more preferably about 0.5 to about 3 g per serving, and most preferably about 1.0 to about 2.0 g per serving.

Fiber blends as described herein can also be used in the preparation of a solid ingestible composition like an extruded food product where the fiber blend is a source of the soluble anionic fiber. A useful fiber blend can include an alginate soluble anionic fiber and a pectin soluble anionic fiber. A ratio of total alginate to total pectin in a blend can be from about 8:1 to about 5:1, or any value therebetween, such as about 7:1, about 6.5:1, about 6.2:1, or about 6.15:1. A ratio of a medium molecular weight alginate to a low molecular weight alginate can range from about 0.65:1 to about 2:1, or any value therebetween.

An alginate soluble anionic fiber in a blend can be a mixture of two or more alginate forms, e.g., a medium and low molecular weight alginate. In certain cases, a ratio of a medium molecular weight alginate to a low molecular weight alginate is about 0.8:1 to about 0.9:1. The high molecular weight alginate has been tested at about 0-2 g. The fiber blend combining low and medium molecular weight alginates with high methoxy pectin has been tested at about 0 to about 3 grams. The preferred range for both would be about 1 to about-2 grams.

The at least one soluble anionic fiber may be treated before, during, or after incorporation into an ingestible composition. For example, the at least one soluble anionic fiber can be processed, e.g., extruded, roll-dried, freeze-dried, dry blended, roll-blended, agglomerated, coated, or spray-dried.

For solid forms, a variety of formed shapes of food products can be prepared by methods known to those having ordinary skill in the art. Extruding, molding, pressing, wire-cutting, and the like. For example, a single or double screw extruder can be used. Typically, a feeder meters in the raw ingredients to a barrel that includes the screw(s). The screw(s) conveys the raw material through the die that shapes the final product. Extrusion can take place under high temperatures and pressures or can be a non-cooking, forming process. Extruders are commercially available, e.g., from Buhler, Germany. Extrusion can be cold or hot extrusion.

Other processing methods are known to those having skilled in the art.

The amount of the at least one soluble anionic fiber included can vary, and will depend on the type of ingestible composition and the type of soluble anionic fiber used. For example, typically a solid ingestible composition will include from about 0.5 g to about 10 g total soluble anionic fiber per serving or any value therebetween. In certain cases, an extruded food product can include an soluble anionic fiber at a total amount from about 22% to about 40% by weight of the extruded product or any value therebetween. In other cases, an extruded food product can include an soluble anionic fiber in a total amount of from about 4% to about 15% or any value therebetween, such as when only gellan is used. In yet other cases, an extruded food product can include an soluble anionic fiber at a total amount of from about 18% to about 25% by weight, for example, when combinations of gellan and alginate or gellan and pectin are used.

In addition to the at least one soluble anionic fiber, a solid ingestible composition can include ingredients that may be treated in a similar manner as the at least one soluble anionic fiber. For example, such ingredient can be co-extruded with the soluble anionic fiber, co-processed with the soluble anionic fiber, or co-spray-dried with the soluble anionic fiber. Such treatment can help to reduce sliminess of the ingestible composition in the mouth and to aid in hydration and gellation of the fibers in the stomach and/or small intestine. Without being bound by any theory, it is believed that co-treatment of the soluble anionic fiber(s) with such ingredient prevents early gellation and hydration of the fibers in the mouth, leading to sliminess and unpalatability. In addition, co-treatment may delay hydration and subsequent gellation of the soluble anionic fibers (either with other soluble anionic fibers or with divalent cations) until the ingestible composition reaches the stomach and/or small intestine, providing for the induction of satiety and/or satiation.

Additional ingredients can be hydrophilic in nature, such as starch, protein, maltodextrin, and inulin. Other additional ingredients can be insoluble in water (e.g., cocoa solids, corn fiber) and/or fat soluble (vegetable oil), or can be flavor modifiers such as sucralose. For example, an extruded food product can include from about 5 to about 80% of a cereal ingredient, such as about 40% to about 68% of a cereal ingredient. A cereal ingredient can be rice, corn, wheat, sorghum, oat, or barley grains, flours, or meals. Thus, an extruded food product can include about 40% to about 50%, about 50% to about 58%, about 52% to about 57%, or about 52%, about 53%, about 54%, about 55%, about 56%, or about 56.5% of a cereal ingredient. In one embodiment, about 56.5% of rice flour is included.

An ingestible composition can also include a protein source. A protein source can be included in the composition or in an extruded food product. For example, an extruded food product can include a protein source at about 2% to about 20% by weight, such as about 3% to about 8%, about 3% to about 5%, about 4% to about 7%, about 4% to about 6%, about 5% to about 7%, about 5% to about 15%, about 10% to about 18%, about 15% to about 20%, or about 8% to about 18% by weight. A protein can be any known to those having ordinary skill in the art, e.g., rice, milk, egg, wheat, whey, soy, gluten, or soy flour. In some cases, a protein source can be a concentrate or isolate form.

Milk Source

The compositions and associated methods of this invention include milk source in an amount sufficient to cause an increase in viscosity of the a soluble nionic fiber. The milk source can be fluid or solid products. Milk for producing dairy products generally comes from cows, but may also come from goats, sheep, water buffalo, yaks, or horses. Fluid forms include fluid milk, ice cream, gelato, yogurt, cream, buttermilk, condensed milk, evaporated milk, and the like. Solid products include cheese, creme fraiche, butter, cream cheese, powdered milk, and the like.

The milk source may be incorporated into or onto an ingestible composition provided herein, or can consumed as a separate food article either before, after, or simultaneously with a fiber-containing ingestible composition.

Table 1 sets for the typical amount of calcium found in a typical serving of fluid milk products.

TABLE 1
1 cup (8 oz) Fluid Milk

| | Calories (Kcal) | Fat (g) | Calcium (mg) |
|---|---|---|---|
| Whole | 149 | 7.7 | 291 |
| 2% Reduced Fat | 121 | 4.4 | 296 |
| 1% Lowfat | 104 | 2.2 | 312 |
| Nonfat | 90 | 0.5 | 316 |
| Chocolate, Whole | 208 | 8.0 | 280 |
| Chocolate, 2% | 178 | 4.7 | 284 |
| Reduced Fat | | | |
| Chocolate, 1% | 157 | 2.3 | 286 |
| Lowfat | | | |

Source: USDA Nutrient Database for Standard Reference.

Divalent cations may also be used in the present invention. Divalent cations useful in this invention include non-dairy calcium, magnesium, aluminum, manganese, iron, nickel, copper, zinc, strontium, barium, bismuth, chromium, vanadium, lanthanum, their salts and mixtures thereof. Salts of the divalent cations may be organic acid salts that include formate, fumarate, acetate, propionate, butyrate, caprylate, valerate, lactate, citrate, malate and gluconate. Also included are highly soluble inorganic salts such as chlorides or other halide salts.

The divalent cation can be unable to, or be limited in ability to, react with the at least one soluble anionic fiber in the ingestible composition until during or after ingestion. For example, physical separation of the divalent cation from the at least one soluble anionic fiber, e.g., as a separate food article or in a separate matrix of the ingestible composition from the at least one soluble anionic fiber, can be used to limit at least the additional divalent cation's ability to react. In other cases, the additional divalent cation is limited in its ability to react with the at least one soluble anionic fiber by protecting the source of at least one divalent cation until during or after ingestion. Thus, the additional divalent cation, such as, a protected additional divalent cation, can be included in the ingestible composition or can be included as a separate food article composition, e.g., for separate ingestion either before, during, or after ingestion of an ingestible composition.

Typically, a separate food article containing the milk source can be consumed in an about four hour time window flanking the ingestion of an ingestible composition containing the at least one soluble anionic fiber. In certain cases, the window may be about three hours, or about two hours, or about one hour. In other cases, the separate food article may be consumed immediately before or immediately after ingestion of an ingestible composition, e.g., within about fifteen minutes, such as within about 10 minutes, about 5 minutes., or about 2 minutes. In other cases, a separate food article containing the milk source can be ingested simultaneously with an ingestible composition containing the at least one soluble anionic fiber, e.g., a cookie composition containing the at least anionic fiber consumed with a serving of whole milk.

In one embodiment, the milk source can be included in an ingestible composition in a different food matrix from a matrix containing an soluble anionic fiber. For example, a cheese pizza can contain a milk source in cheese and the at least one soluble anionic fiber can be in the dough. Thus, means for physical separation of an soluble anionic fiber from a source of dairy calcium are also contemplated.

Additional divalent cations can be in a matrix such as a frosting, water and fat based icing, coating, decorative topping, drizzle, chip, chunk, swirl, filling, or interior layer

One divalent cation source is divalent cation salts. Typically, a divalent cation salt can be selected from the following salts: citrate, tartrate, malate, formate, lactate, gluconate, phosphate, carbonate, sulfate, chloride, acetate, proponate, butyrate, caprylate, valerate, fumarate, adipate, and succinate. In certain cases, the additional divalent cation salt is a calcium salt. A calcium salt can have a solubility of >1% w/vol in water at pH 7 at 20° C. A calcium salt can be, without limitation, calcium fumarate, tricalcium phosphate, calcium citrate, calcium carbonate, calcium tartrate, calcium malate, calcium lactate, calcium gluconate, calcium citrate malate, dicalcium phosphate dihydrate, anhydrous calcium diphosphate, dicalcium phosphate anhydrous, calcium carbonate, calcium sulfate dihydrate, calcium sulfate anhydrous, calcium chloride, calcium acetate monohydrate, monocalcium phosphate monohydrate, and monocalcium phosphate anhydrous.

A number of methods can be used to protect a source of at least one divalent cation. For example, microparticles or nanoparticles having double or multiple emulsions, such as water/oil/water (“w/o/w”) or oil/water/oil (“o/w/o”) emulsions, of at least one divalent cation and an soluble anionic fiber can be used. In one embodiment, a calcium alginate microparticle or nanoparticle is used. For example, a calcium chloride solution can be emulsified in oil, which emulsion can then be dispersed in a continuous water phase containing the anionic alginate soluble fiber. When the emulsion breaks in the stomach, the calcium can react with the alginate to form a gel.

A microparticle can have a size from about 1 to about 15 μM (e.g., about to about 10 μM, or about 3 to about 8 μM). A nanoparticle can have a size of about 11 to about 85 nm (e.g., about 15 to about 50 nm, about 30 to about 80 nm, or about 50 to about 75 nm). The preparation of multiple or double emulsions, including the choice of surfactants and lipids, is known to those having ordinary skill in the art.

In another embodiment, nanoparticles of calcium alginate are formed by preparing nanodroplet w/o microemulsions of CaCl₂ in a solvent and nanodroplet w/o microemulsions of alginate in the same solvent. When the two microemulsions are mixed, nanoparticles of calcium alginate are formed. The particles can be collected and dispersed, e.g., in a fluid ingestible composition. As the particle size is small (<100 nm), the particles stay dispersed (e.g., by Brownian motion), or can be stabilized with a food grade surfactant. Upon ingestion, the particles aggregate and gel.

In other embodiments, a liposome containing a source of at least one divalent cation can be included in an ingestible composition. For example, a calcium-containing liposome can be used. The preparation of liposomes containing divalent cations is well known to those having ordinary skill in the art; see ACS Symposium Series, 1998 709:203-211; Chem. Mater. 1998 (109-116). Cochelates can also be used, e.g., as described in U.S. Pat. No. 6,592,894 and U.S. Pat. No. 6,153,217. The creation of cochelates using divalent cations such as calcium can protect the divalent cations from reacting with the soluble anionic fiber within the aqueous phase of an ingestible composition, e.g., by wrapping the divalent cations in a hydrophobic lipid layer, thus delaying reaction with the fiber until digestion of the protective lipids in the stomach and/or small intestine via the action of lipases.

In certain cases, a divalent cation-containing carbohydrate glass can be used, such as a calcium containing carbohydrate glass. A carbohydrate glass can be formed from any carbohydrate such as, without limitation, sucrose, trehalose, inulin, maltodextrin, corn syrup, fructose, dextrose, and other mono-, di-, or oligo-saccharides using methods known to those having ordinary skill in the art; see, e.g., WO 02/05667. A carbohydrate glass can be used, e.g., in a coating or within a food matrix.

Ingestible Compositions

Compositions of the present invention can be in any form, fluid, solid or combinations thereof. Fluids can be beverages, including shake, liquado, and smoothie. Fluids can be from low to high viscosity.

Solid forms can extruded or not. Solid forms may include bread, cracker, bar, mini-bars, cookie, confectioneries, e.g., nougats, toffees, fudge, caramels, hard candy enrobed soft core, muffins, cookies, brownies, cereals, chips, snack foods, bagels, chews, crispies, and nougats, pudding, jelly, and jam. Solids can have densities from low to high.

Fluids

Fluid ingestible compositions can be useful for, among other things, aiding in weight loss programs, e.g., as meal replacement beverages or diet drinks. Fluid ingestible compositions can provide from about 0.5 g to about 10 g of soluble anionic fiber per serving, or any value therebetween. For example, in certain cases, about 1 g, about 2 g, about 3 g, about 4 g, about 5 g, about 6 g, about 7 g, about 8 g, or about 9 g of at least one soluble anionic fiber are provided per serving.

A fluid ingestible composition may include an alginate soluble anionic fiber and/or a pectin soluble anionic fiber. In certain cases, an alginate soluble anionic fiber and a pectin soluble anionic fiber are used. A fiber blend as described herein can be used to provide the soluble anionic fiber and/or the pectin soluble anionic fiber. An alginate and pectin can be any type and in any form, as described previously. For example, an alginate can be a high, medium, or low molecular weight range alginate, and a pectin can be a high-methoxy pectin. Also as indicated previously, two or more alginate forms can be used, such as a high molecular weight and a low molecular weight alginate, or two high molecular weight alginates, or two low molecular weight alginates, or a low and a medium molecular weight alginate, etc. For example, Manugel GHB alginate and/or Manugel LBA alginate can be used. In other cases, Manugel DPB can be used. Genu Pectin, USPL200 (a high-methoxy pectin) can be used as a pectin. In certain cases, potassium salt forms of an soluble anionic fiber can be used, e.g., to reduce the sodium content of an ingestible composition.

A fluid ingestible composition includes alginate and/or pectin in a total amount of about 0.3% to about 5% by weight, or any value therebetween, e.g., about 1.25% to about 1.9%; about 1.4% to about 1.8%; about 1.0% to about 2.2%, about 2.0% to about 4.0%, about 3.0%, about 4.0%, about 2.0%, about 1.5%, or about 1.5% to about 1.7%. Such percentages of total alginate and pectin can yield about 2 g to about 8 g of fiber per 8 oz. serving, e.g., about 3 g, about 4 g, about 5 g, about 6 g, or about 7 g fiber per 8 oz. serving. In other cases, about 4 g to about 8 g of fiber (e.g., about 5 g, about 6 g, or about 7 g) per 12 oz. serving can be targeted. In some embodiments, about 1.7% fiber by weight of a fluid ingestible composition is targeted.

In some cases, a fluid ingestible composition includes only alginate as a soluble anionic fiber. In other cases, alginate and pectin are used. A ratio of alginate to pectin (e.g., total alginate to total pectin) in a fluid ingestible composition can range from about 8:1 to about 1:8, and any ratio therebetween (e.g., alginate:pectin can be in a ratio of about 1:1, about 1.2:1, about 1.3:1, about 1.4:1, about 1.5:1, about 1.6:1, about 1.62:1, about 1.7:1, about 1.8:1, about 1.9:1, about 2:1, about 3:1, about 4:1, about 5:1, about 5.3:1, about 5.6:1, about 5.7:1, about 5.8:1, about 5.9:1, about 6:1, about 6.1:1, about 6.5:1, about 7:1, about 7.5:1, about 7.8:1, about 2:3, about 1:4, or about 0.88:1). In cases where alginate and pectin are in a ratio of about 0.5:1 to about 2:1, it is believed that pectin and alginate electrostatically associate with one another to gel in the absence of divalent cations; thus, while not being bound by theory, it may be useful to delay the introduction of divalent cations (see methods below) until after such gel formation. In other cases, where the ratio of alginate to pectin is in the range from about 3:1 to about 8:1, it may be useful to include a divalent cation source such as a calcium source (e.g., to crosslink the excess alginate) to aid gel formation in the stomach. In these cases, the inventors believe, while not being bound by any theory, that the lower amount of pectin protects the alginate from precipitating as alginate at the low pHs of the stomach environment, while the divalent cation source cross-links and stabilizes the gels formed.

A fluid ingestible composition can have a pH from about 3.9 to about 4.5, e.g., about 4.0 to about 4.3 or about 4.1 to about 4.2. At these pHs, it is believed that the fluid ingestible compositions are above the pKas of the alginate and pectin acidic subunits, minimizing precipitation, separation, and viscosity of the solutions. In some cases, malic, phosphoric, and citric acids can be used to acidify the compositions. In some cases, a fluid ingestible composition can have a pH of from about 5 to about 7.5. Such fluid ingestible compositions can use pH buffers known to those having ordinary skill in the art.

Sweeteners for use in a fluid ingestible composition can vary according to the use of the composition. For diet beverages, low glycemic sweeteners may be preferred, including trehalose, isomaltulose, aspartame, saccharine, and sucralose. Sucralose can be used alone in certain formulations. The choice of sweetener will impact the overall caloric content of a fluid ingestible composition. In certain cases, a fluid ingestible compositions can be targeted to have 40 calories/12 oz serving.

A fluid ingestible composition can demonstrate gel strengths of about 20 to about 250 grams force (e.g., about 60 to about 240, about 150 to about 240, about 20 to 30, about 20 to about 55, about 50 to 200; about 100 to 200; and about 175 to 240), as measured in a static gel strength assay. Gel strengths can be measured in the presence and absence of a divalent cation source, such as a calcium source.

A fluid ingestible composition can exhibit a viscosity in the range of from about 15 to about 100 cPs, or any value therebetween, at a shear rate of about 10⁻⁵, e.g., about 17 to about 24; about 20 to about 25; about 50 to 100, about 25 to 75, about 20 to 80, or about 15 to about 20 cPs. Viscosity can be measured by those skilled in the art, e.g., by measuring flow curves of solutions with increasing shear rate using a double gap concentric cyclinder fixture (e.g., with a Parr Physica Rheometer).

A fluid ingestible composition can include a divalent cation sequestrant, e.g., to prevent premature gellation of the soluble anionic fibers. A divalent cation sequestrant can be selected from EDTA and its salts, EGTA and its salts, sodium citrate, sodium hexametaphosphate, sodium acid pyrophosphate, trisodium phosphate anhydrous, tetrasodium pyrophosphate, sodium tripolyphosphate, disodium phosphate, sodium carbonate, and potassium citrate. A divalent cation sequestrant can be from about 0.001% to about 0.3% by weight of the ingestible composition. Thus, for example, EDTA can be used at about 0.0015% to about 0.002% by weight of the ingestible composition and sodium citrate at about 0.230% to about 0.260% (e.g., 0.250%) by weight of the ingestible composition.

A fluid ingestible composition can include a juice or juice concentrate and optional flavorants and/or colorants. Juices for use include fruit juices such as apple, grape, raspberry, blueberry, cherry, pear, orange, melon, plum, lemon, lime, kiwi, passionfruit, blackberry, peach, mango, guava, pineapple, grapefruit, and others known to those skilled in the art. Vegetable juices for use include tomato, spinach, wheatgrass, cucumber, carrot, peppers, beet, and others known to those skilled in the art.

The brix of the juice or juice concentrate can be in the range of from about 15 to about 85 degrees, such as about 25 to about 50 degrees, about 40 to about 50 degrees, about 15 to about 30 degrees, about 65 to about 75 degrees, or about 70 degrees. A fluid ingestible composition can have a final brix of about 2 to about 25 degrees, e.g., about 5, about 10, about 12, about 15, about 20, about 2.5, about 3, about 3.5, about 3.8, about 4, or about 4.5.

Flavorants can be included depending on the desired final flavor, and include flavors such as kiwi, passionfruit, pineapple, coconut, lime, creamy shake, peach, pink grapefruit, peach grapefruit, pina colada, grape, banana, chocolate, vanilla, cinnamon, apple, orange, lemon, cherry, berry, blueberry, blackberry, apple, strawberry, raspberry, melon(s), coffee, and others, available from David Michael, Givaudan, Duckworth, and other sources.

Colorants can also be included depending on the final color to be achieved, in amounts quantum satis that can be determined by one having ordinary skill in the art.

Solids

At least one soluble anionic fiber can be present in a solid ingestible composition in any form or in any mixtures of forms. A form can be a processed, unprocessed, or both. Processed forms include extruded forms, spray-dried forms, wire-cut forms, roll-dried forms, or dry-blended forms. For example, a snack bar can include at least anionic soluble anionic fiber present as an extruded food product (e.g., a crispy), at least one soluble anionic fiber in an unextruded form (e.g., as part of the bar), or both.

An extruded food product can be cold- or hot-extruded and can assume any type of extruded form, including without limitation, a bar, cookie, bagel, crispy, puff, curl, crunch, ball, flake, square, nugget, and snack chip. In some cases, an extruded food product is in bar form, such as a snack bar or granola bar. In some cases, an extruded food product is in cookie form. In other cases, an extruded food product is in a form such as a crispy, puff, flake, curl, ball, crunch, nugget, chip, square, chip, or nugget. Such extruded food products can be eaten as is, e.g., cookies, bars, chips, and crispies (as a breakfast cereal) or can be incorporated into a solid ingestible composition, e.g., crispies incorporated into snack bars.

A solid form may also be a lollipop or a lolly that is made of hardened, flavored sugar mounted on a stick and intended for sucking or licking. One form of lollipop has a soft-chewy filling in the center of the hardened sugar. The soft filling may be a gum, fudge, toffee, caramel, jam, jelly or any other soft-chewy filling known in the art. The at least one divalent cation may be in the soft-chewy center or the harnend sugar. Likewise, at least fiber may be in the soft-chewy center or the harnend sugar. A hard candy filled with a soft-chewy center is another embodiment of the present invention. This embodiment is similar to the lollipop, except it is not mounted on a stick. The soft-chewy filling may be in the center or swirled or layered with the hard sugar confection.

A cookie or mini-bar can include at least one soluble anionic fiber in an unprocessed form or in a processed (e.g., extruded) form. A snack chip can include at least one soluble anionic fiber in extruded form or in spray-dried form, or both, e.g., an extruded soluble anionic fiber-containing chip having at least one anionic soluble fiber spray-dried on the chip.

A solid ingestible composition can include optional additions such as frostings, icings, coatings, toppings, drizzles, chips, chunks, swirls, or layers. Such optional additions can include at least one divalent cation, at least one soluble anionic fiber, or both.

Solid ingestible compositions can provide any amount from about 0.5 g to about 10 g total soluble anionic fiber per serving, e.g., about 0.5 g to about 5 g, about 1 g to about 6 g, about 3 g to about 7 g, about 5 g to about 9 g, or about 4 g to about 6 g. For example, in some cases, about 1 g, about 2 g, about 3 g, about 4 g, about 5 g, about 6 g, about 7 g, about 8 g, or about 9 g of soluble anionic fiber per serving can be provided.

A solid ingestible composition can include at least one soluble anionic fiber at a total weight percent of the ingestible composition of from about 4% to about 50% or any value therebetween. For example, a solid ingestible composition can include at least one soluble anionic fiber of from about 4% to about 10% by weight; or about 5% to about 15% by weight; or about 10% to about 20% by weight; or about 20% to about 30% by weight; or about 30% to about 40% by weight; or about 40% to about 50% by weight.

An extruded food product can be from about 0% to 100% by weight of an ingestible composition, or any value therebetween (about 1% to about 5%; about 5% to about 10%; about 10% to about 20%; about 20% to about 40%; about 30% to about 42%; about 35% to about 41%; about 37% to about 42%; about 42% to about 46%; about 30% to about 35%; about 40% to about 50%; about 50% to about 60%; about 60% to about 70%; about 70% to about 80%; about 80% to about 90%; about 90% to about 95%; about 98%; or about 99%). For example, an extruded bar, cookie, or chip can be about 80% to about 100% by weight of an ingestible composition or any value therebetween.

Alternatively, an ingestible composition can include about 30% to about 55% by weight of an extruded food product or any value therebetween, e.g., about 32%, about 33%, about 34%, about 35%, about 36%, about 37%, 3 about 8%, about 39%, about 40%, about 42%, about 45%, about 48%, about 50%, about 52%, or about 54% by weight of an extruded food product. For example, a snack bar composition can include extruded crispies in an amount of from about 32% to about 46% by weight of the snack bar.

Crispies

An extruded food product, e.g., for inclusion in an ingestible composition, can be a crispy. For example, crispies that include one or more alginates and/or pectins in a total amount of about 30% to about 35% by weight can be included in a snack bar in an amount of about 32% to about 45% by weight of the snack bar. Crispies can be prepared using a fiber blend as described herein. Crispies can also include, among other things, about 52% to about 58% by weight of one or more of a rice flour, corn meal, and/or corn cone; and about 2% to about 10% of a protein isolate. Crispies can be prepared using methods known to those having ordinary skill in the art, including cold and hot extrusion techniques.

An ingestible composition can include one or more of the following: cocoa, including flavonols, and oils derived from animal or vegetable sources, e.g., soybean oil, canola oil, corn oil, safflower oil, sunflower oil, etc. For example, an extruded food product can include cocoa or oils in an amount of about 3% to about 10% (e.g., about 3% to about 6%, about 4% to about 6%, about 5%, about 6%, about 7%, or about 4% to about 8%) by weight of the extruded food product.

One embodiment of the present invention is a stable two phase product having at least one soluble anionic fiber and at least one divalent cation in the same product, but formulated so that the soluble anionic fiber and dairy calcium do not react during processing or prior to ingestion, but react following ingestion as a standard cation-anion fiber reaction. One product design includes a cheese portion and a crisp baked phase outside the cheese phase. One embodiment places the soluble anionic fiber in the baked dough phase and places the milk source in the cheese phase.

An appropriate serving of the fiber-containing composition contains from about 50 to about 200 kcal, preferably from about 50 to about 100 kcal.

BENEFAT® is a family of triglyceride blends made from the short and long chain fatty acids commonly present in the diet. It is the uniqueness of these fatty acids that contribute to the range's reduced calorie claim. BENEFAT® products are designed to replace conventional fats and oils in dairy, confectionery and bakery products, giving full functionality with significantly reduced energy and fat content. BENEFAT® is the Danisco trade name for SALATRIM, the abbreviation for short and long-chain triglyceride molecules. The short-chain acids (C₂-C₄) may be acetic, propionic, butyric or a combination of all three, while the long-chain fatty acid (C₁₆-C₂₂) is predominantly stearic and derived from fully hardened vegetable oil. Unlike other saturated fatty acids, stearic acid has a neutral effect on blood cholesterol. BENEFAT® is also free of trans fatty acids and highly resistant to oxidation. Compared to the 9 calories per gram of traditional fat, BENEFAT® contains just 5 calories per gram (US regulation) or 6 calories per gram (EU regulation), at the same time giving foods a similar creamy taste, texture, and mouthfeel as full-fat products. Metabolisation upon consumption occurs in much the same way as with other food components.

The soluble anionic fiber may be delivered in a beverage component and a milk source may be provided separately in a solid edible component. The fluid fiber component and the solid milk component are consumed concurrently or sequentially.

The soluble anionic fiber component may be provided in a solid edible component, and the milk source may be provided separately in a fluid component. The fluid milk source component and the solid fiber-containing component are consumed concurrently or sequentially.

The soluble anionic fiber component and the milk source are both provided in solid edible components. The components may be provided in the form of separate items for consumption, or both components may be combined in a single solid form for consumption. This single solid form may contain the soluble anionic fiber in one phase, such as, a layer or filling, and the milk source may be provided in a separate phase, such as a layer or filling. Alternatively, the fiber and milk source may be intimately mixed in the same solid form.

The ingestible composition of the present invention can be provided in any package, such as enclosed in a wrapper or included in a container. An ingestible composition can be included in an article of manufacture. An article of manufacture that includes an ingestible composition described herein can include auxiliary items such as straws, napkins, labels, packaging, utensils, etc.

Methods of Reducing Caloric Consumption

An soluble anionic fiber (such as alginate and pectin) is administered concurrently with milk source. Continued use of these compositions by individuals in need of weight loss will result in a cumulative decrease in caloric consumption, which will result in weight loss or diminished weight gain. Although not wishing to be bound by theory, the inventors hypothesize that the divalent cation calcium ions of the soluble calcium source cross link the carboxylate groups on the fiber molecules, resulting in the formation of highly viscous or gelled materials. This gelling effect increases the viscosity of the gastric and intestinal contents, slowing gastric emptying, and also slowing the rate of macro-nutrient, e.g., glucose, amino acids, fatty acids, and the like, absorption. These physiological effects prolong the period of nutrient absorption after a meal, and therefore prolong the period during which the individual experiences an absence of hunger. The increased viscosity of the gastrointestinal contents, as a result of the slowed nutrient absorption, also causes a distal shift in the location of nutrient absorption. This distal shift in absorption may trigger the so-called “ileal brake”, and the distal shift may also cause in increase in the production of satiety hormones such as GLP-1 and PYY.

Provided herein are methods employing the ingestible compositions described herein. For example, a method of facilitating satiety and/or satiation in an animal is provided. The method can include administering an ingestible composition to an animal. An animal can be any animal, including a human, monkey, mouse, rat, snake, cat, dog, pig, cow, sheep, bird, or horse. Administration can include providing the ingestible combination either alone or in combination with other meal items. Administration can include co-administering, either before, after, or during administration of the ingestible composition, a milk source described herein. The milk source can be administered within about a four hour time window flanking the administration of the ingestible composition. Satiety and/or satiation can be evaluated using consumer surveys (e.g., for humans) that can demonstrate a statistically significant measure of increased satiation and/or satiety. Alternatively, data from paired animal sets showing a statistically significant reduction in total caloric intake or food intake in the animals administered the ingestible compositions can be used as a measure of facilitating satiety and/or satiation.

As indicated previously, the ingestible compositions provide herein can hydrate and gel in the stomach and/or small intestine, leading to increased viscosity in the stomach and/or small intestine after ingestion. Accordingly, provided herein are methods for increasing the viscosity of stomach and/or small intestine contents, which include administering an ingestible composition to an animal. An animal can be any animal, as described above, and administration can be as described previously. Viscosity of stomach contents can be measured by any method known to those having ordinary skill in the art, including endoscopic techniques, imaging techniques (e.g., MRI), or in vivo or ex vivo viscosity measurements in e.g., control and treated animals.

Also provided are methods for promoting weight loss by administering an ingestible composition as provided herein to an animal. Administration can be as described previously. The amount and duration of such administration will depend on the individual's weight loss needs and health status, and can be evaluated by those having ordinary skill in the art. The animal's weight loss can be measured over time to determine if weight loss is occurring. Weight loss can be compared to a control animal not administered the ingestible composition.

The following examples are representative of the invention, and are not intended to be limiting to the scope of the invention.

### EXAMPLES

### Example 1

A cookie having a solid phase, e.g., a baked dough phase, containing a soluble anionic fiber blend and a fluid phase, e.g., jam phase containing a soluble calcium source deposited in the baked dough phase was produced.

The baked dough phase was prepared by adding BENEFAT® and lecithin to a premix of flour, cellulose, egg white, salt, leavening and flavors in a Hobart mixer and creaming by mixing at low speed for about 1 minute followed by high speed for about 2 minutes. The liquids were added to creamed mixture and blended at medium speed for about 2 minutes.

The fiber blend used contained about 46% sodium alginate LBA (ISP, San Diego, Calif.), about 39.6% sodium alginate GHB (ISP), and about 14.4% pectin (USP-L200, Kelco, San Diego, Calif.).

The fiber blend and glycerin were added to a separate bowl and combined. This combined fiber/glycerin material was added to the other ingredients in the Hobart mixer and was mixed on medium speed for about 1 minute. The resulting dough was then sheeted to desired thickness on a Rhondo sheeter and a dough pad measuring about 3 inched by about 6 inches was created.

The jam phase was prepared by adding a premixed BENEFAT®/calcium source mixture to the jam base and mixed until uniformly mixed. A predetermined amount of the jam was then added onto the top surface of the cookie dough pad. The dough pad edges were wetted and sealed. Bars were baked at 325° F. for about 9 minutes, cut, cooled and the resulting cookies were individually packaged. The total caloric value of each cookie was about 50 kcal.

| | % Dough | % Total |
|---|---|---|
| Ingredient | Phase | Formulation |
| Flour all purpose | 29.140 | 12.165 |
| Cellulose, solka floc - | 6.980 | 2.914 |
| International Fiber Corp. | | |
| Powder egg white | 0.580 | 0.242 |
| Salt (NaCl) | 0.200 | 0.083 |
| Sodium Bicarbonate Grade #1 | 0.510 | 0.213 |
| Cookie Dough Flavor | 0.170 | 0.071 |
| BENEFAT | 2.060 | 0.860 |
| Lecithin | 0.640 | 0.267 |
| Polydextrose Litesse 70% syrup, | 15.870 | 6.625 |
| Ultra | | |
| Water | 11.830 | 4.939 |
| Liquid Vanilla flavor | 0.280 | 0.117 |
| sucralose, 25% liquid. | 0.090 | 0.038 |
| Potassium sorbate | 0.250 | 0.104 |
| Alginate fiber blend | 17.400 | 7.264 |
| Glycerine, Optim 99.7% USP | 14.000 | 5.845 |
| | 100.000 | 41.70 |

### Example 2

### Fudge Confection

The confection contains 10-15% grams of sodium alginate (Cargill, Inc, Minneapolis, Minn.), about 17 to about 25% reducing sugar solids about 45 to about 55% sugar, about 20% fat and milk solids, and about 7 to about 10% moisture. The fudge confection is prepared by any method known in the art. The resulting confection is a fudge confection containing around 20 kcal per individual peice.

### Example 3

About one hour after a breakfast of a banana and cup of decaffeinated coffee, a 50 year old male subject, with a BMI of 25.5, consumes a single piece of the fudge confection produced in Example 2. About 15 minutes after the chew is ingested, the subject consumes 8 ounces of 2% fluid milk. The subject reports no desire to eat lunch, and minimal desire to eat at dinnertime. While the subject does eat lunch, he consumes 3 pretzels during the day and eats a dinner of Hunan Beef and Broccoli, steamed rice, and an egg roll (King Tien Restaurant, Limekiln RD, Horsham, Pa.). The total caloric intake for the day is less than that required to maintain weight for the subject, based on USDA recommended food intake charts.

### Example 4

The male subject in Example 3, repeats the experiment on the following day. All conditions were identical. The subject again reported no desire to eat lunch, and minimal desire to eat at dinnertime. The subject did not eat lunch, consumed snacks during the day that included 3 pretzels, and a dinner of 3 slices of plain cheese pizza, a small garden salad, and buttered roll (Sons of Italy Pizzeria, Bethlehem Pike, Fort Washington, Pa.). The caloric intake for the day is less than that needed to maintain weight for the subject, based on USDA recommended food intake charts.

What is claimed is:

1. A method for inducing satiety in an animal, the method comprising the step of ingesting at least one soluble anionic fiber and a milk source.

2. A method for inducing satiety in an animal of claim 1, wherein the at least one soluble anionic fiber is in a solid ingestible composition and the milk source is in a fluid composition.

3. A method for inducing satiety in an animal of claim 2, wherein the at least one soluble anionic fiber is selected from the group consisting of alginate, pectin, gellan, soluble fibers that contain carboxylate substituents, carrageenan, polygeenan, marine algae-derived polymers that contain sulfate substituents, and mixtures thereof.

4. A method for inducing satiety in an animal of claim 3, wherein the at least one soluble anionic fiber is a mixture of alginate and pectin.

5. A method for inducing satiety in an animal of claim 4, wherein alginate and pectin are present in a total amount of from about 0.5 g to about 10 g per serving.

6. A method for inducing satiety in an animal of claim 1, wherein the wherein the at least soluble anionic fiber is in a solid ingestible composition and the milk source is in a solid composition.

7. A method for inducing satiety in an animal of claim 6, wherein the at least one soluble anionic fiber is selected from the group consisting of alginate, pectin, gellan, soluble fibers that contain carboxylate substituents, carrageenan, polygeenan, marine algae-derived polymers that contain sulfate substituents, and mixtures thereof.

8. A method for inducing satiety in an animal of claim 7, wherein the at least one soluble anionic fiber is a mixture of alginate and pectin.

9. A method for inducing satiety in an animal of claim 8, wherein alginate and pectin are present in a total amount of from about 0.5 g to about 10 g per serving.

10. A method for inducing satiety in an animal of claim 1, wherein the at least one soluble anionic fiber is in a fluid composition and the milk source is in a fluid composition.

11. A method for inducing satiety in an animal of claim 10, wherein the at least one soluble anionic fiber is selected from the group consisting of alginate, pectin, gellan, soluble fibers that contain carboxylate substituents, carrageenan, polygeenan, marine algae-derived polymers that contain sulfate substituents, and mixtures thereof.

12. A method for inducing satiety in an animal of claim 11, wherein the at least one soluble anionic fiber is a mixture of alginate and pectin.

13. A method for inducing satiety in an animal of claim 12, wherein alginate and pectin are present in a total amount of from about 0.5 g to about 10 g per serving.

14. A method for inducing satiety in an animal of claim 1, wherein the at least one soluble anionic fiber is in a fluid ingestible composition and the milk source is in a solid composition.

15. A method for inducing satiety in an animal of claim 14, wherein the at least one soluble anionic fiber is selected from the group consisting of alginate, pectin, gellan, soluble fibers that contain carboxylate substituents, carrageenan, polygeenan, marine algae-derived polymers that contain sulfate substituents, and mixtures thereof.

16. A method for inducing satiety in an animal of claim 15, wherein the at least one soluble anionic fiber is a mixture of alginate and pectin.

17. A method for inducing satiety in an animal of claim 16, wherein alginate and pectin are present in a total amount of from about 0.5 g to about 10 g per serving.

18. A method for reducing caloric intake in an animal, the method comprising the step of administering to the animal an effective amount of at least one soluble anionic fiber and a milk source.

19. A method for reducing caloric intake in an animal of claim 18, wherein the at least one soluble anionic fiber is in a solid ingestible composition and the milk source is fluid composition.

20. A method for reducing caloric intake in an animal of claim 19, wherein the at least one soluble anionic fiber is selected from the group consisting of alginate, pectin, gellan, soluble fibers that contain carboxylate substituents, carrageenan, polygeenan, marine algae-derived polymers that contain sulfate substituents, and mixtures thereof.

21. A method for reducing caloric intake in an animal of claim 20, wherein the at least one soluble anionic fiber is a mixture of alginate and pectin.

22. A method for reducing caloric intake in an animal of claim 21, wherein alginate and pectin are present in a total amount of from about 0.5 g to about 10 g per serving.

23. A method for reducing caloric intake in an animal of claim 18, wherein the at least one soluble anionic fiber in a solid ingestible composition and the milk source is in a solid composition.

24. A method for reducing caloric intake in an animal of claim 23, wherein the at least one soluble anionic fiber is selected from the group consisting of alginate, pectin, gellan, soluble fibers that contain carboxylate substituents, carrageenan, polygeenan, marine algae-derived polymers that contain sulfate substituents, and mixtures thereof.

25. A method for reducing caloric intake in an animal of claim 24, wherein the at least one soluble anionic fiber is a mixture of alginate and pectin.

26. A method for reducing caloric intake in an animal of claim 25, wherein alginate and pectin are present in a total amount of from about 0.5 g to about 10 g per serving.

27. A method for reducing caloric intake in an animal of claim 26 wherein the wherein the at least one soluble anionic fiber is in a fluid ingestible composition and the milk source is in a fluid composition.

28. A method for reducing caloric intake in an animal of claim 27, wherein the at least one soluble anionic fiber is selected from the group consisting of alginate, pectin, gellan, soluble fibers that contain carboxylate substituents, carrageenan, polygeenan, marine algae-derived polymers that contain sulfate substituents, and mixtures thereof.

29. A method for reducing caloric intake in an animal of claim 28, wherein the at least one soluble anionic fiber is a mixture of alginate and pectin.

30. A method for reducing caloric intake in an animal of claim 29, wherein alginate and pectin are present in a total amount of from about 0.5 g to about 10 g per serving.

31. A method for reducing caloric intake in an animal of claim 18, wherein the wherein the at least one soluble anionic fiber is in a fluid ingestible composition and the milk source is in a solid composition.

32. A method for reducing caloric intake in an animal of claim 31, wherein the at least one soluble anionic fiber is selected from the group consisting of alginate, pectin, gellan, soluble fibers that contain carboxylate substituents, carrageenan, polygeenan, marine algae-derived polymers that contain sulfate substituents, and mixtures thereof.

33. A method for reducing caloric intake in an animal of claim 32, wherein the at least one soluble anionic fiber is a mixture of alginate and pectin.

34. A method for reducing caloric intake in an animal of claim 33, wherein alginate and pectin are present in a total amount of from about 0.5 g to about 10 g per serving.

35. A method for reducing weight in an animal, the method comprising the step of administering to the animal at least one soluble anionic fiber and a milk source.

36. A method for reducing weight in an animal of claim 35, wherein the at least one soluble anionic fiber in a solid ingestible composition and the milk source is in a fluid composition.

37. A method for reducing weight in an animal of claim 36, wherein the at least one soluble anionic fiber is selected from the group consisting of alginate, pectin, gellan, soluble fibers that contain carboxylate substituents, carrageenan, polygeenan, marine algae-derived polymers that contain sulfate substituents, and mixtures thereof.

38. A method for reducing weight in an animal of claim 37, wherein the at least one soluble anionic fiber is a mixture of alginate and pectin.

39. A method for reducing weight in an animal of claim 38, wherein alginate and pectin are present in a total amount of from about 0.5 g to about 10 g per serving.

40. A method for reducing weight in an animal of claim 35, wherein the wherein the at least one soluble anionic fiber in a solid ingestible composition and the milk source is in a solid composition.

41. A method for reducing weight in an animal of claim 40, wherein the at least one soluble anionic fiber is selected from the group consisting of alginate, pectin, gellan, soluble fibers that contain carboxylate substituents, carrageenan, polygeenan, marine algae-derived polymers that contain sulfate substituents, and mixtures thereof.

42. A method for reducing weight in an animal of claim 41, wherein the at least one soluble anionic fiber is a mixture of alginate and pectin.

43. A method for reducing weight in an animal of claim 42, wherein alginate and pectin are present in a total amount of from about 0.5 g to about 10 g per serving.

44. A method for reducing weight in an animal of claim 43, wherein the at least one soluble anionic fiber is in a fluid ingestible composition and the milk source is in a fluid composition.

45. A method for reducing weight in an animal of claim 44, wherein the at least one soluble anionic fiber is selected from the group consisting of alginate, pectin, gellan, soluble fibers that contain carboxylate substituents, carrageenan, polygeenan, marine algae-derived polymers that contain sulfate substituents, and mixtures thereof.

46. A method for reducing weight in an animal of claim 45, wherein the at least one soluble anionic fiber is a mixture of alginate and pectin.

47. A method for reducing weight in an animal of claim 46, wherein alginate and pectin are present in a total amount of from about 0.5 g to about 10 g per serving.

48. A method for reducing weight in an animal of claim 35, wherein the at least one soluble anionic fiber is in a fluid ingestible composition and the milk source is in a solid composition.

49. A method for reducing weight in an animal of claim 48, wherein the at least one soluble anionic fiber is selected from the group consisting of alginate, pectin, gellan, soluble fibers that contain carboxylate substituents, carrageenan, polygeenan, marine algae-derived polymers that contain sulfate substituents, and mixtures thereof.

50. A method for reducing weight in an animal of claim 49, wherein the at least one soluble anionic fiber is a mixture of alginate and pectin.

51. A method for reducing weight in an animal of claim 50, wherein alginate and pectin are present in a total amount of from about 0.5 g to about 10 g per serving.
